(19) United States
(12) Patent Application Publication
(10) Pub. No.: US 2013/0132079 A1
(43) Pub. Date: May 23, 2013

(54) INTERACTIVE SPEECH RECOGNITION

(71) Applicants: Muhammad Shoaib B. Sehgal, Bellevue, WA (US); Mirza Muhammad Raza, Vancouver (CA)

(72) Inventors: Muhammad Shoaib B. Sehgal, Bellevue, WA (US); Mirza Muhammad Raza, Vancouver (CA)

(73) Assignee: Microsoft Corporation, Redmond, WA (US)

(21) Appl. No.: 13/298,291

(22) Filed: Nov. 17, 2011

(51) Int. Cl. G10L 15/26

(52) U.S. Cl. 704/235; 704/E15.043

(57) ABSTRACT

A first plurality of audio features associated with a first utterance may be obtained. A first text result associated with a first speech-to-text translation of the first utterance may be obtained based on an audio signal analysis associated with the audio features, the first text result including at least one first word. A first set of audio features correlated with at least a first portion of the first speech-to-text translation associated with the at least one first word may be obtained. A display of at least a portion of the first text result that includes the at least one first word may be initiated. A selection indication may be received, indicating an error in the first speech-to-text translation, the error associated with the at least one first word.

### BACKGROUND

Users of electronic devices are increasingly relying on information obtained from the Internet as sources of news reports, ratings, descriptions of items, announcements, event information, and other various types of information that may be of interest to the users. Further, users are increasingly relying on automatic speech recognition systems to ease their frustrations in manually entering text for many applications such as searches, requesting maps, requesting auto-dialed telephone calls, and texting.

### SUMMARY

According to one general aspect, a computer program product tangibly embodied on a computer-readable storage medium may include executable code that may cause at least one data processing apparatus to obtain audio data associated with a first utterance. Further, the at least one data processing apparatus may obtain, via a device processor, a text result associated with a first speech-to-text translation of the first utterance based on an audio signal analysis associated with the audio data, the text result including a plurality of selectable text alternatives corresponding to at least one word. Further, the at least one data processing apparatus may initiate a display of at least a portion of the text result that includes a first one of the text alternatives. Further, the at least one data processing apparatus may receive a selection indication indicating a second one of the text alternatives.

According to another aspect, a first plurality of audio features associated with a first utterance may be obtained. A first text result associated with a first speech-to-text translation of the first utterance may be obtained based on an audio signal analysis associated with the audio features, the first text result including at least one first word. A first set of audio features correlated with at least a first portion of the first speech-to-text translation associated with the at least one first word may be obtained. A display of at least a portion of the first text result that includes the at least one first word may be initiated. A selection indication may be received, indicating an error in the first speech-to-text translation, the error associated with the at least one first word.

According to another aspect, a system may include an input acquisition component that obtains a first plurality of audio features associated with a first utterance. The system may also include a speech-to-text component that obtains, via a device processor, a first text result associated with a first speech-to-text translation of the first utterance based on an audio signal analysis associated with the audio features, the first text result including at least one first word. The system may also include a clip correlation component that obtains a first correlated portion of the first plurality of audio features associated with the first speech-to-text translation to the at least one first word. The system may also include a result delivery component that initiates an output of the first text result and the first correlated portion of the first plurality of audio features. The system may also include a correction request acquisition component that obtains a correction request that includes an indication that the at least one first word is a first speech-to-text translation error, and the first correlated portion of the first plurality of audio features.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for interactive speech recognition.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

FIG. 5 depicts an example interaction with the system of FIG. 1.

FIG. 6 depicts an example interaction with the system of FIG. 1.

FIG. 7 depicts an example interaction with the system of FIG. 1.

FIG. 8 depicts an example interaction with the system of FIG. 1.

FIG. 9 depicts an example interaction with the system of FIG. 1.

FIG. 10 depicts an example user interface for the system of FIG. 1.

### DETAILED DESCRIPTION

As users of electronic devices increasingly rely on information obtained from the devices themselves or the Internet, they are also increasingly relying on automatic speech recognition systems to ease their frustrations in manually entering text for many applications such as searches, requesting maps, requesting auto-dialed telephone calls, and texting.

For example, a user may wish to speak one or more words into a mobile device and receive results via the mobile device almost instantaneously, from the perspective of the user. For example, the mobile device may receive the speech signal as the user utters the word(s), and may either process the speech signal on the device itself, or may send the speech signal (or pre-processed audio features extracted from the speech signal) to one or more other devices (e.g., backend servers or “the cloud”) for processing. A recognition engine may then recognize the signal and send the corresponding text to the device. If the recognition engine misclassifies one or more words of the user's utterance (e.g., returns a homonym or near-homonym to one or more words intended by the user), the user wish to avoid re-uttering all of his/her previous utterance, or uttering a different word or phrase in hopes that the recognition may be able to recognize the user's intent in the different word(s), or manually entering the text instead of relying on speech recognition a second time.

Example techniques discussed herein may provide speech-to-text recognition based on correlating audio clips with portions of an utterance that correspond to the individual words or phrases translated from the correlated portions of audio data corresponding to the speech signal (e.g., audio features).

Example techniques discussed herein may provide a user interface with a display of speech-to-text results that include selectable text for receiving user input with regard to incorrectly translated (i.e., misclassified) words or phrases. According to an example embodiment, a user may touch an incorrectly translated word, and may receive a display of corrected results that do not include the incorrectly translated word or phrase.

According to an example embodiment, the user may touch an incorrectly translated word, and may receive a display of corrected results that include the next k most probable alternative translated words instead of the incorrectly translated word.

According to an example embodiment, a user may touch an incorrectly translated word, and may receive a display of a drop-down menu the displays the next k most probable alternative translated words instead of the incorrectly translated word.

According to an example embodiment, the user may receive a display of the translation result that may include a list of alternative words resulting from the text-to-speech translation, enclosed in delimiters such as parentheses or brackets. The user may then select the correct alternative, and may receive further results of an underlying application (e.g., search results, map results, sending text).

According to an example embodiment, the user may receive a display of the translation result that may include further results of the underlying application (e.g., search results, map results) with the initial translation, and with each corrected translation.

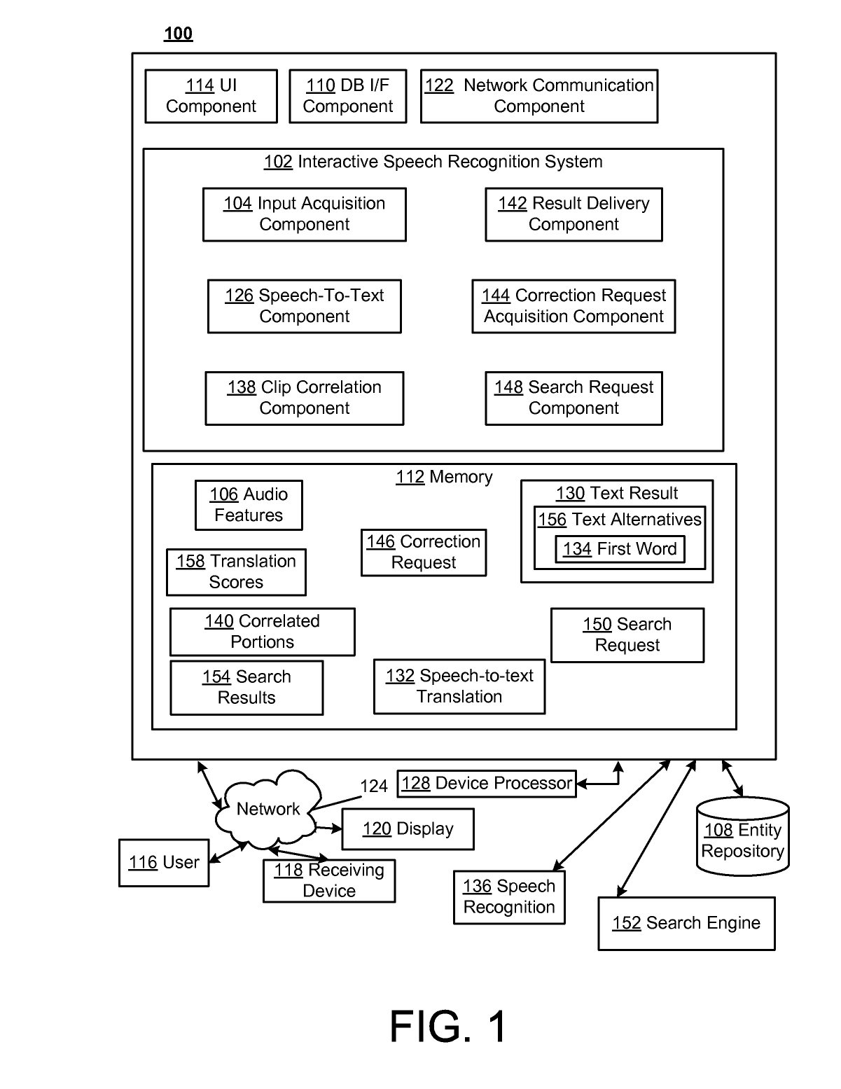

As further discussed herein, FIG. 1 is a block diagram of a system 100 for interactive speech recognition. As shown in FIG. 1, a system 100 may include an interactive speech recognition system 102 that includes an input acquisition component 104 that may obtain a first plurality of audio features 106 associated with a first utterance. For example, the audio features may include audio signals associated with a human utterance of a phrase that may include one or more words. For example the audio features may include audio signals associated with a human utterance of letters of an alphabet (e.g., a human spelling one or more words). For example, the audio features may include audio data resulting from processing of audio signals associated with an utterance, for example, processing from an analog signal to a numeric digital form, which may also be compressed for storage, or for more lightweight transmission over a network.

According to an example embodiment, the interactive speech recognition system 102 may include executable instructions that may be stored on a computer-readable storage medium, as discussed below. According to an example embodiment, the computer-readable storage medium may include any number of storage devices, and any number of storage media types, including distributed devices.

For example, an entity repository 108 may include one or more databases, and may be accessed via a database interface component 110. One skilled in the art of data processing will appreciate that there are many techniques for storing repository information discussed herein, such as various types of database configurations (e.g., SQL SERVERS) and non-database configurations.

According to an example embodiment, the interactive speech recognition system 102 may include a memory 112 that may store the first plurality of audio features 106. In this context, a “memory” may include a single memory device or multiple memory devices configured to store data and/or instructions. Further, the memory 112 may span multiple distributed storage devices.

According to an example embodiment, a user interface component 114 may manage communications between a user 116 and the interactive speech recognition system 102. The user 116 may be associated with a receiving device 118 that may be associated with a display 120 and other input/output devices. For example, the display 120 may be configured to communicate with the receiving device 118, via internal device bus communications, or via at least one network connection.

According to an example embodiment, the interactive speech recognition system 102 may include a network communication component 122 that may manage network communication between the interactive speech recognition system 102 and other entities that may communicate with the interactive speech recognition system 102 via at least one network 124. For example, the at least one network 124 may include at least one of the Internet, at least one wireless network, or at least one wired network. For example, the at least one network 124 may include a cellular network, a radio network, or any type of network that may support transmission of data for the interactive speech recognition system 102. For example, the network communication component 122 may manage network communications between the interactive speech recognition system 102 and the receiving device 118. For example, the network communication component 122 may manage network communication between the user interface component 114 and the receiving device 118.

According to an example embodiment, the interactive speech recognition system 102 may communicate directly (not shown in FIG. 1) with the receiving device 118, instead of via the network 124, as depicted in FIG. 1. For example, the interactive speech recognition system 102 may reside on one or more backend servers, or on a desktop device, or on a mobile device. For example, although not shown in FIG. 1, the user 116 may interact directly with the receiving device 118, which may host at least a portion of the interactive speech recognition system 102, at least a portion of the device processor 128, and the display 120. According to example embodiments, portions of the system 100 may operate as distributed modules on multiple devices, or may communicate with other portions via one or more networks or connections, or may be hosted on a single device.

A speech-to-text component 126 may obtain, via a device processor 128, a first text result 130 associated with a first speech-to-text translation 132 of the first utterance based on an audio signal analysis associated with the audio features 106, the first text result 130 including at least one first word 134. For example, the first speech-to-text translation 132 may be obtained via a speech recognition operation, via a speech recognition system 136. For example, the speech recognition system 136 may reside on a same device as other components of the interactive speech recognition system 102, or may communicate with the interactive speech recognition system 102 via a network connection.

In this context, a “processor” may include a single processor or multiple processors configured to process instructions associated with a processing system. A processor may thus include multiple processors processing instructions in parallel and/or in a distributed manner. Although the device processor 128 is depicted as external to the interactive speech recognition system 102 in FIG. 1, one skilled in the art of data processing will appreciate that the device processor 128 may be implemented as a single component, and/or as distributed units which may be located internally or externally to the interactive speech recognition system 102, and/or any of its elements.

A clip correlation component 138 may obtain a first correlated portion 140 of the first plurality of audio features 106 associated with the first speech-to-text translation 132 to the at least one first word 134. For example, an utterance by the user 116 of a street address such as the multi-word phrase “ONE MICROSOFT WAY” may be associated with audio features that include a first set of audio features associated with an utterance of “ONE”, a second set of audio features associated with an utterance of “MICROSOFT”, and a third set of audio features associated with an utterance of “WAY”. As the utterance of the three words may occur in sequence, the first, second, and third sets of these audio features may be based on three substantially nonoverlapping timing intervals among the three sets. For this example, the clip correlation component 138 may obtain a first correlated portion 140 (e.g., the first set of audio features) associated with the first speech-to-text translation 132 to the at least one first word 134 (e.g., the portion of the first speech-to-text translation 132 of the first set audio features 106, associated with the utterance of “ONE”).

A result delivery component 142 may initiate an output of the first text result 130 and the first correlated portion 140 of the first plurality of audio features 106. For example, the first text result 130 may include a first word 134 indicating “WON” as a speech-to-text translation of the utterance of the homonym “ONE”. For example, both “WON” and “ONE” may be correlated to the first set of audio features associated with an utterance of “ONE”. For this example, the result delivery component 142 may initiate an output of the text result 130 and the correlated portion 140 (e.g., the first set of audio features associated with an utterance of “ONE”).

A correction request acquisition component 144 may obtain a correction request 146 that includes an indication that the at least one first word is a first speech-to-text translation error, and the first correlated portion 140 of the audio features. For example, the correction request acquisition component 144 may obtain a correction request 146 that includes an indication that “WON” is a first speech-to-text translation error, and the correlated portion 140 (e.g., the first set of audio features associated with an utterance of “ONE”).

According to an example embodiment, a search request component 148 may initiate a first search operation based on the first text result 130 associated with the first speech-to-text translation 132 of the first utterance. For example, the search request component 148 may send a search request 150 to a search engine 152. For example, if the first text result 130 includes “WON MICROSOFT WAY”, then a search may be requested on “WON MICROSOFT WAY”.

According to an example embodiment, the result delivery component 142 may initiate the output of the first text result 130 and the first correlated portion 140 of the first plurality of audio features 106 with results 154 of the first search operation. For example, the result delivery component 142 may initiate the output of the first text result 130 associated with “WON MICROSOFT WAY” with results of the search.

According to an example embodiment, the speech-to-text component 104 may obtain, via the device processor 128, the first text result 130 associated with the first speech-to-text translation 132 of the first utterance based on the audio signal analysis associated with the first plurality of audio features 106, the first text result 130 including a plurality of text alternatives 156, the at least one first word 134 included in the plurality of first text alternatives 156. For example, the utterance by the user 116 of the street address such as the multi-word phrase “ONE MICROSOFT WAY” may be associated (and correlated) with audio features that include a first set of audio features associated with an utterance of “ONE”, a second set of audio features associated (and correlated) with an utterance of “MICROSOFT”, and a third set of audio features associated (and correlated) with an utterance of “Way”. For example, the plurality of text alternatives 156 (e.g., as translation of the audio features associated with the utterance of “ONE”) may include homonyms, or near-homonyms “WON”, “ONE”, “WAN”, and “EUN”.

According to an example embodiment, the first correlated portion 140 of the first plurality of audio features 106 associated with the first speech-to-text translation 132 to the at least one first word 134 is associated with the plurality of first text alternatives 156. For the example “ONE MICROSOFT WAY”, first correlated portion 140 may include the first set of audio features associated with an utterance of “ONE”. Thus, this example first correlated portion 140 may be associated with the plurality of first text alternatives 156, or “WON”, “ONE”, “WAN”, and “EUN”.

According to an example embodiment, each of the plurality of first text alternatives 156 is associated with a corresponding translation score 158 indicating a probability of correctness in text-to-speech translation. For example, the speech recognition system 136 may perform a text-to-speech analysis of the audio features 106 associated with an utterance of “ONE MICROSOFT WAY”, and may provide text alternatives for each of the three words included in the phrase. For example, each alternative may be associated with a translation score 158 which may indicate a probability that the particular associated alternative is a “correct” text-to-speech translation of the correlated portions 140 of the audio features 106. According to an example embodiment, the alternative(s) having the highest translation scores 158 may be provided as first words 134 (e.g., for a first display to the user 116, or for a first search request).

According to an example embodiment, the at least one first word 134 may be associated with a first translation score 158 indicating a highest probability of correctness in text-to-speech translation among the plurality of first text alternatives 156.

According to an example embodiment, the output of the first text result 130 includes an output of the plurality of first text alternatives 156 and the corresponding translation scores 158. For example, the result delivery component 142 may initiate the output of the first text alternatives 156 and the corresponding translation scores 158.

According to an example embodiment, the result delivery component 142 may initiate the output of the first text result 130, the first correlated portion 140 of the first plurality of audio features 106, and at least a portion of the corresponding translation scores 158. For the example user utterance of “ONE MICROSOFT WAY”, the result delivery component 142 may initiate the output of “WON MICROSOFT WAY” with alternatives for each word (e.g., “WON”, “ONE”, “WAN”, “EUN”—as well as “WAY”, “WEIGH”, “WHEY”), correlated portions of the first plurality of audio features 106 (e.g., the first set of audio features associated with the utterance of “ONE” and the third set of audio features associated with the utterance of “WAY”), and their corresponding translation scores (e.g., 0.5 for “WON”, 0.4 for “ONE”, 0.4 for “WAY”, 0.3 for “WEIGH”).

According to an example embodiment, the correction request acquisition component 144 may obtain the correction request 146 that includes the indication that the at least one first word 134 is a first speech-to-text translation error, and one or more of the first correlated portion 140 of the first plurality of audio features 106, and the at least a portion of the corresponding translation scores 158, or a second plurality of audio features 106 associated with a second utterance corresponding to verbal input associated with a correction of the first speech-to-text translation error based on the at least one first word 134. For example, the correction request 146 may include an indication that “WON” is a first speech-to-text translation error, with the first correlated portion 140 (e.g., the first set of audio features associated with the utterance of “ONE”), and the corresponding translation scores 158 (e.g., 0.5 for “WON”, 0.4 for “ONE”). For example, the correction request 146 may include an indication that “WON” is a first speech-to-text translation error, with a second plurality of audio features 106 associated with another utterance of “ONE”, as a correction utterance.

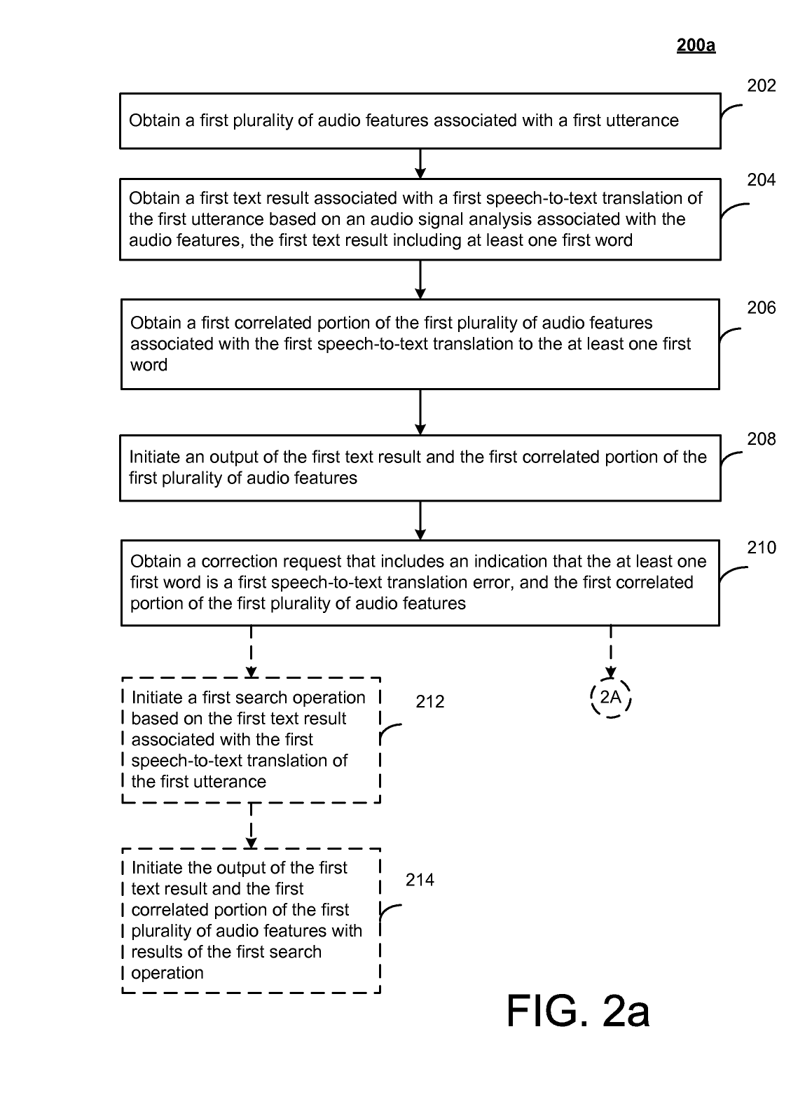

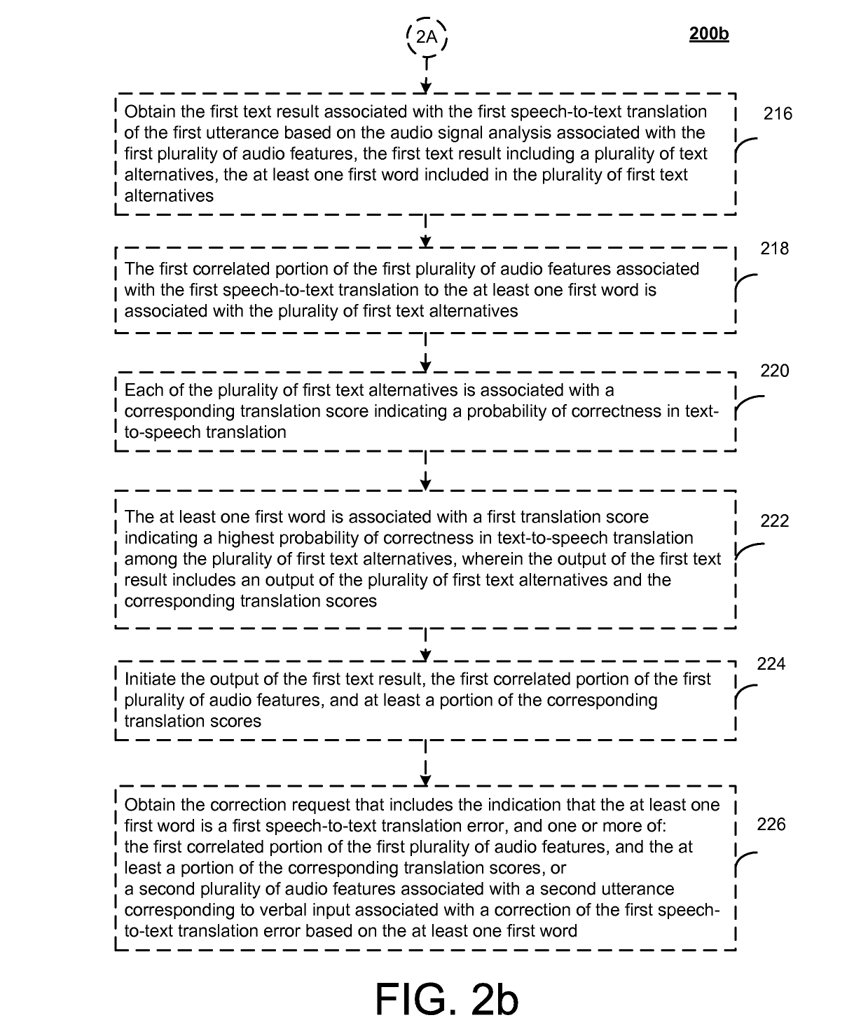

FIG. 2 is a flowchart illustrating example operations of the system of FIG. 1, according to example embodiments. In the example of FIG. 2a, a first plurality of audio features associated with a first utterance may be obtained (202). For example, the input acquisition component 104 may obtain the first plurality of audio features 106 associated with the first utterance, as discussed above.

A first text result associated with a first speech-to-text translation of the first utterance may be obtained, based on an audio signal analysis associated with the audio features, the first text result including at least one first word (204). For example, the speech-to-text component 126 may obtain, via the device processor 128, the first text result 130 associated with the first speech-to-text translation 132 of the first utterance based on an audio signal analysis associated with the audio features 106, the first text result 130 including at least one first word 134, as discussed above.

A first correlated portion of the first plurality of audio features associated with the first speech-to-text translation to the at least one first word may be obtained (206). For example, the clip correlation component 138 may obtain the first correlated portion 140 of the first plurality of audio features 106 associated with the first speech-to-text translation 132 to the at least one first word 134, as discussed above.

An output of the first text result and the first correlated portion of the first plurality of audio features may be initiated (208). For example, the result delivery component 142 may initiate an output of the first text result 130 and the first correlated portion 140 of the first plurality of audio features 106, as discussed above.

A correction request that includes an indication that the at least one first word is a first speech-to-text translation error, and the first correlated portion of the first plurality of audio features, may be obtained (210). For example, the correction request acquisition component 144 may obtain a correction request 146 that includes an indication that the at least one first word is a first speech-to-text translation error, and the first correlated portion 140 of the audio features, as discussed above.

According to an example embodiment, a first search operation may be initiated, based on the first text result associated with the first speech-to-text translation of the first utterance (212). For example, the search request component 148 may initiate a first search operation based on the first text result 130 associated with the first speech-to-text translation 132 of the first utterance, as discussed above.

According to an example embodiment, the output of the first text result and the first correlated portion of the first plurality of audio features with results of the first search operation may be initiated (214). For example, the result delivery component 142 may initiate the output of the first text result 130 and the first correlated portion 140 of the first plurality of audio features 106 with results 154 of the first search operation, as discussed above.

According to an example embodiment, the first text result associated with the first speech-to-text translation of the first utterance based on the audio signal analysis associated with the first plurality of audio features may be obtained, the first text result including a plurality of text alternatives, the at least one first word included in the plurality of first text alternatives (216). For example, the speech-to-text component 104 may obtain, via the device processor 128, the first text result 130 associated with the first speech-to-text translation 132 of the first utterance based on the audio signal analysis associated with the first plurality of audio features 106, the first text result 130 including a plurality of text alternatives 156, the at least one first word 134 included in the plurality of first text alternatives 156, as discussed above.

According to an example embodiment, the first correlated portion of the first plurality of audio features associated with the first speech-to-text translation to the at least one first word is associated with the plurality of first text alternatives (218). For example, the first correlated portion 140 of the first plurality of audio features 106 associated with the first speech-to-text translation 132 to the at least one first word 134 is associated with the plurality of first text alternatives 156, as discussed above.

According to an example embodiment, each of the plurality of first text alternatives may be associated with a corresponding translation score indicating a probability of correctness in text-to-speech translation (220). For example, each of the plurality of first text alternatives 156 is associated with a corresponding translation score 158 indicating a probability of correctness in text-to-speech translation, as discussed above.

According to an example embodiment, the at least one first word may be associated with a first translation score indicating a highest probability of correctness in text-to-speech translation among the plurality of first text alternatives. According to an example embodiment, the output of the first text result may include an output of the plurality of first text alternatives and the corresponding translation scores (222). For example, the at least one first word 134 may be associated with a first translation score 158 indicating a highest probability of correctness in text-to-speech translation among the plurality of first text alternatives 156, as discussed above. For example, the output of the first text result 130 includes an output of the plurality of first text alternatives 156 and the corresponding translation scores 158, as discussed above.

According to an example embodiment, the output of the first text result, the first correlated portion of the first plurality of audio features, and at least a portion of the corresponding translation scores may be initiated (224). For example, the result delivery component 142 may initiate the output of the first text result 130, the first correlated portion 140 of the first plurality of audio features 106, and at least a portion of the corresponding translation scores 158, as discussed above.

According to an example embodiment, the correction request that includes the indication that the at least one first word is a first speech-to-text translation error, and one or more of the first correlated portion of the first plurality of audio features, and the at least a portion of the corresponding translation scores, or a second plurality of audio features associated with a second utterance corresponding to verbal input associated with a correction of the first speech-to-text translation error based on the at least one first word, may be obtained (226). For example, the correction request acquisition component 144 may obtain the correction request 146 that includes the indication that the at least one first word 134 is a first speech-to-text translation error, and one or more of the first correlated portion 140 of the first plurality of audio features 106, and the at least a portion of the corresponding translation scores 158, or a second plurality of audio features 106 associated with a second utterance corresponding to verbal input associated with a correction of the first speech-to-text translation error based on the at least one first word 134, as discussed above.

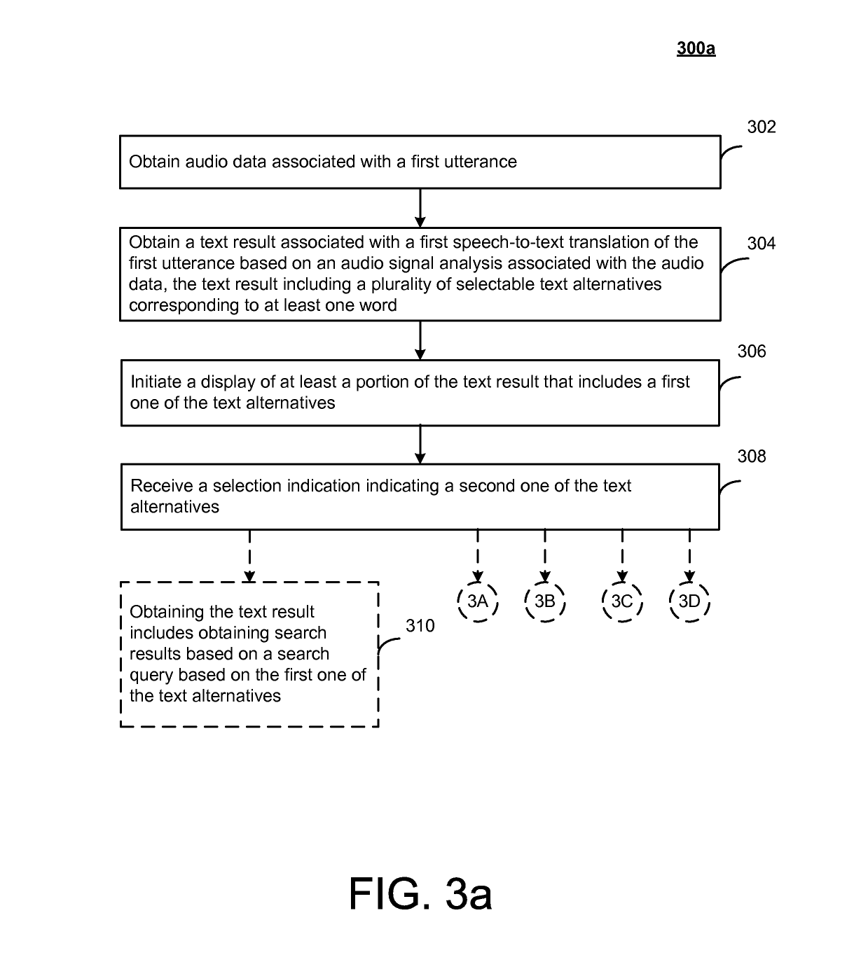

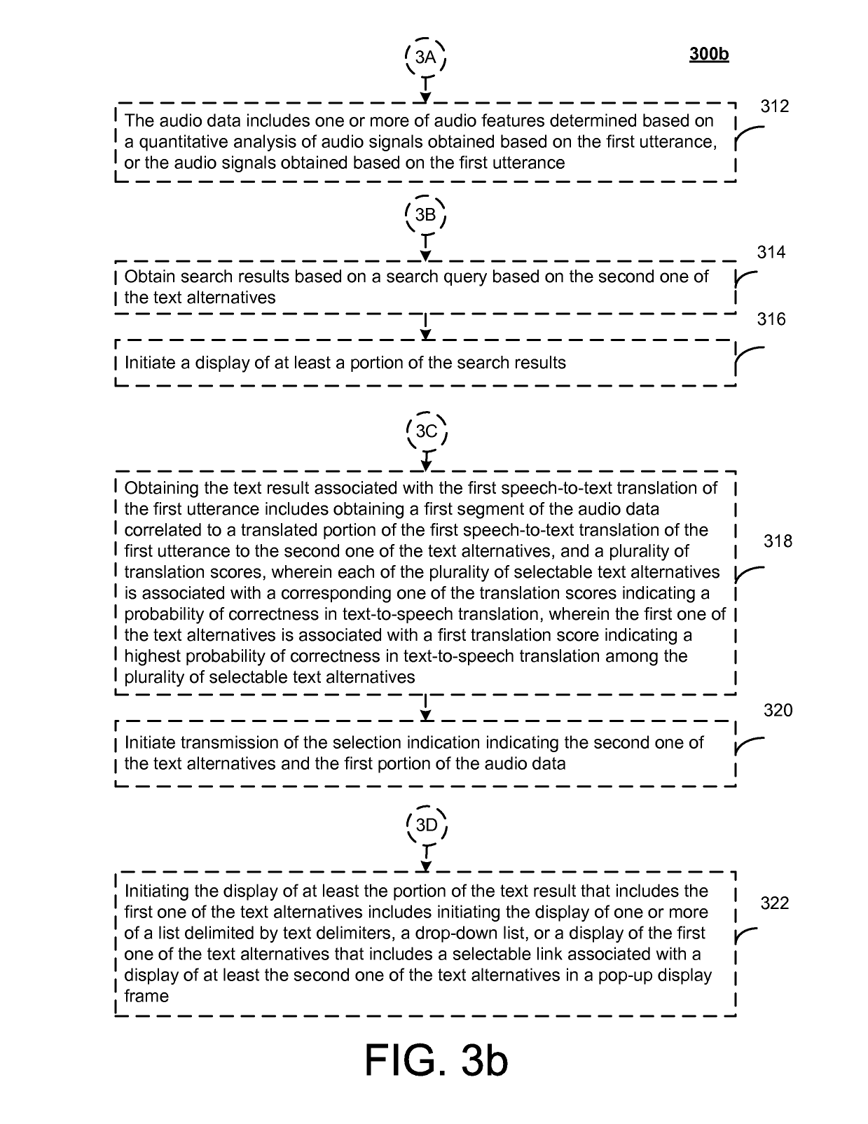

FIG. 3 is a flowchart illustrating example operations of the system of FIG. 1, according to example embodiments. In the example of FIG. 3a, audio data associated with a first utterance may be obtained (302). For example, the input acquisition component 104 may obtain the audio data associated with a first utterance, as discussed above.

A text result associated with a first speech-to-text translation of the first utterance may be obtained based on an audio signal analysis associated with the audio data, the text result including a plurality of selectable text alternatives corresponding to at least one word (304). For example, the speech-to-text component 126 may obtain, via a device processor 128, the first text result 130 associated with a first speech-to-text translation 132 of the first utterance based on an audio signal analysis associated with the audio features 106, as discussed above.

A display of at least a portion of the text result that includes a first one of the text alternatives may be initiated (306). For example, the display may be initiated by the receiving device 118 on the display 120.

A selection indication indicating a second one of the text alternatives may be received (308). For example, the selection indication may be received by the receiving device 118, as discussed further below.

According to an example embodiment, obtaining the text result may include obtaining, via the device processor, search results based on a search query based on the first one of the text alternatives (310). For example, the text result 130 and search results 154 may be received at the receiving device 118, as discussed further below. For example, the result delivery component 142 may initiate the output of the first text result 130 with results 154 of the first search operation, as discussed above.

According to an example embodiment, the audio data may include one or more of audio features determined based on a quantitative analysis of audio signals obtained based on the first utterance, or the audio signals obtained based on the first utterance (312).

According to an example embodiment, search results may be obtained based on a search query based on the second one of the text alternatives (314). For example, the search results 154 may be received at the receiving device 118, as discussed further below. For example, the search request component 148 may initiate a search operation based on the second one of the text alternatives.

According to an example embodiment, a display of at least a portion of the search results may be initiated (316). For example, the display of at least a portion of the search results 154 may be initiated via the receiving device 118 on the display 120, as discussed further below.

According to an example embodiment, obtaining the text result associated with the first speech-to-text translation of the first utterance may include obtaining a first segment of the audio data correlated to a translated portion of the first speech-to-text translation of the first utterance to the second one of the text alternatives, and a plurality of translation scores, wherein each of the plurality of selectable text alternatives is associated with a corresponding one of the translation scores indicating a probability of correctness in text-to-speech translation. According to an example embodiment, the first one of the text alternatives is associated with a first translation score indicating a highest probability of correctness in text-to-speech translation among the plurality of selectable text alternatives (318).

According to an example embodiment, transmission of the selection indication indicating the second one of the text alternatives and the first portion of the audio data may be initiated (320). For example, the receiving device 118 may initiate transmission of the selection indication indicating the second one of the text alternatives and the first portion of the audio data to the interactive speech recognition system 102. For example, the receiving device 118 may initiate transmission of the correction request 146 to the interactive speech recognition system 102.

According to an example embodiment, initiating the display of at least the portion of the text result that includes the first one of the text alternatives may include initiating the display of one or more of a list delimited by text delimiters, a drop-down list, or a display of the first one of the text alternatives that includes a selectable link associated with a display of at least the second one of the text alternatives in a pop-up display frame (322).

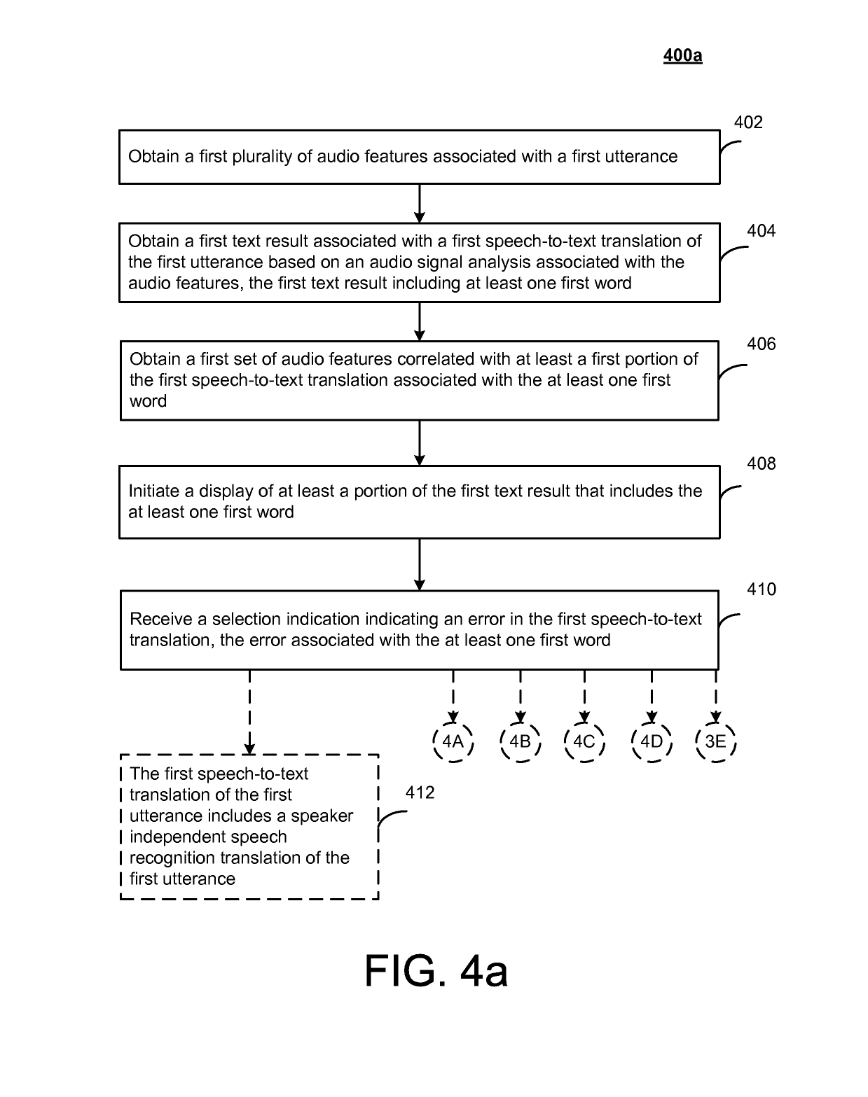

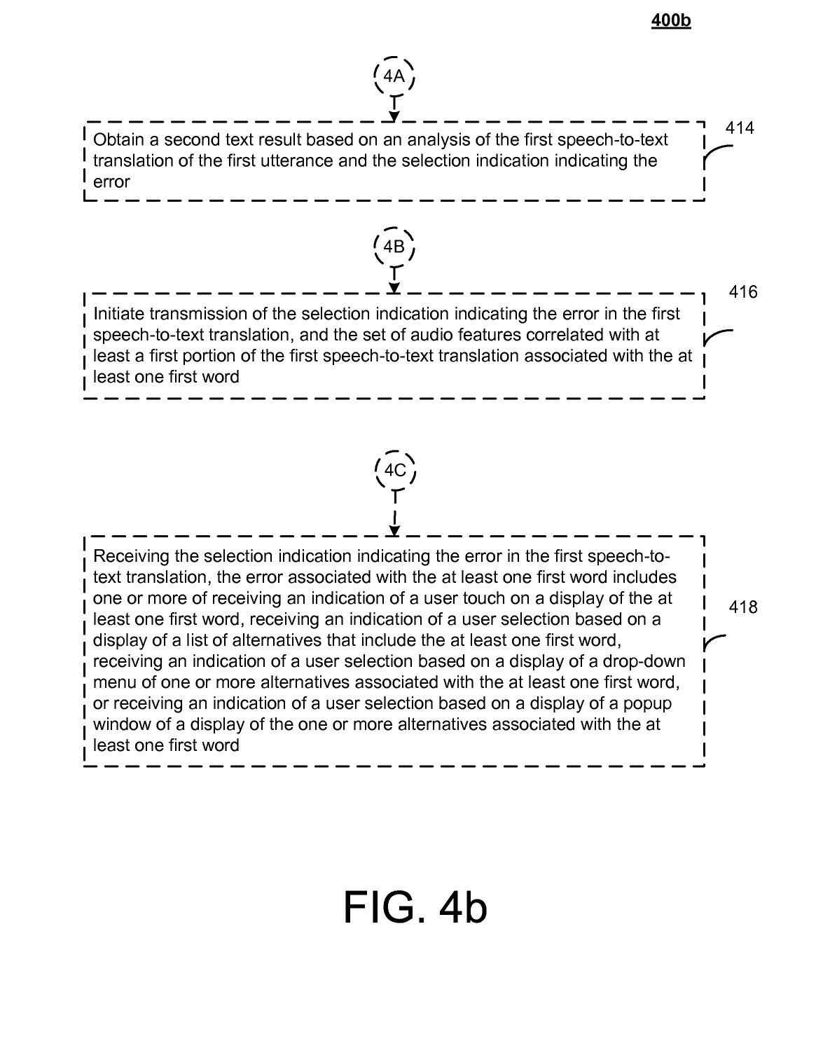

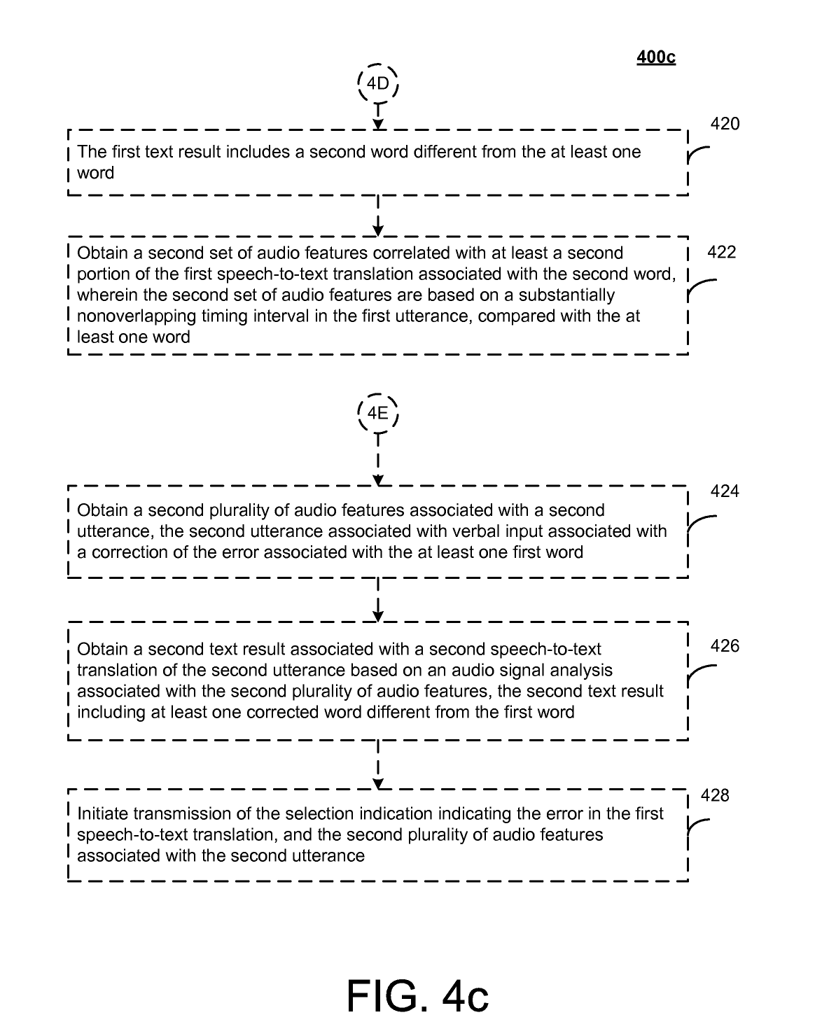

FIG. 4 is a flowchart illustrating example operations of the system of FIG. 1, according to example embodiments. In the example of FIG. 4, a first plurality of audio features associated with a first utterance may be obtained (402). For example, the input acquisition component 104 may obtain a first plurality of audio features 106 associated with a first utterance, as discussed above.

A first text result associated with a first speech-to-text translation of the first utterance may be obtained based on an audio signal analysis associated with the audio features, the first text result including at least one first word (404). For example, the speech-to-text component 126 may obtain, via the device processor 128, the first text result 130, as discussed above. For example, the receiving device 118 may receive the first text result 130 from the interactive speech recognition system 102, for example, via the result delivery component 142.

A first set of audio features correlated with at least a first portion of the first speech-to-text translation associated with the at least one first word may be obtained (406). For example, the clip correlation component 138 may obtain the first correlated portion 140 of the first plurality of audio features 106 associated with the first speech-to-text translation 132 to the at least one first word 134, as discussed above. For example, the receiving device 118 may obtain the least a first portion of the first speech-to-text translation associated with the at least one first word from the interactive speech recognition system 102, for example, via the result delivery component 142.

A display of at least a portion of the first text result that includes the at least one first word may be initiated (408). For example, the receiving device 118 may initiate the display, as discussed further below.

A selection indication may be received, indicating an error in the first speech-to-text translation, the error associated with the at least one first word (410). For example, the receiving device 118 may initiate the display, as discussed further below. For example, the correction request acquisition component 144 may obtain the selection indication via the correction request 146, as discussed above.

According to an example embodiment, the first speech-to-text translation of the first utterance may include a speaker independent speech recognition translation of the first utterance (412).

According to an example embodiment, a second text result may be obtained based on an analysis of the first speech-to-text translation of the first utterance and the selection indication indicating the error (414). For example, the speech-to-text component 126 may obtain the second text result. For example, the result delivery component 142 may initiate an output of the second text result. For example, the receiving device 118 may obtain the second text result.

According to an example embodiment, transmission of the selection indication indicating the error in the first speech-to-text translation, and the set of audio features correlated with at least a first portion of the first speech-to-text translation associated with the at least one first word, may be initiated (416). For example, the receiving device 118 may initiate the transmission to the interactive speech recognition system 102.

According to an example embodiment, the selection indication indicating the error in the first speech-to-text translation may be received, the error associated with the at least one first word may include one or more of receiving an indication of a user touch on a display of the at least one first word, receiving an indication of a user selection based on a display of a list of alternatives that include the at least one first word, receiving an indication of a user selection based on a display of a drop-down menu of one or more alternatives associated with the at least one first word, or receiving an indication of a user selection based on a display of a popup window of a display of the one or more alternatives associated with the at least one first word (418). For example, the receiving device 118 may receive the selection indication from the user 116, as discussed further below. For example, the input acquisition component 140 may receive the selection indication, for example, from the receiving device 118.

According to an example embodiment, the first text result may include a second word different from the at least one word (420). For example, the first text result 130 may include a second word of a multi-word phrase translated from the audio features 106. For example, the second word may include a speech recognition translation of second keyword of a search query entered by the user 116.

According to an example embodiment, a second set of audio features correlated with at least a second portion of the first speech-to-text translation associated with the second word may be obtained, wherein the second set of audio features are based on a substantially nonoverlapping timing interval in the first utterance, compared with the at least one word (422). For example, the second set of audio features may include audio features associated with the audio signal associated with an utterance by the user of a second word that is distinct from the at least one word, in a multi-word phrase. For example, an utterance by the user 116 of the multi-word phrase “ONE MICROSOFT WAY” may be associated with audio features that include a first set of audio features associated with the utterance of “ONE”, a second set of audio features associated with the utterance of “MICROSOFT”, and a third set of audio features associated with the utterance of “WAY”. As the utterance of the three words may occur in sequence, the first, second, and third sets of these audio features may be based on three substantially nonoverlapping timing intervals among the three sets.

According to an example embodiment, a second plurality of audio features associated with a second utterance may be obtained, the second utterance associated with verbal input associated with a correction of the error associated with the at least one first word (424). For example, the user 116 may select a word of the first returned text result 130 for correction, and may speak the intended word again, as the second utterance. The second plurality of audio features associated with the second utterance may then be sent to the correction request acquisition component (e.g., via a correction request 146) for further processing by the interactive speech recognition system 102, as discussed above. According to an example, embodiment, the correction request 146 may include an indication that the at least one first word is not a candidate for text-to-speech translation of the second plurality of audio features.

According to an example embodiment a second text result associated with a second speech-to-text translation of the second utterance may be obtained, based on an audio signal analysis associated with the second plurality of audio features, the second text result including at least one corrected word different from the first word (426). For example, the receiving device 118 may obtain the second text result 130 from the interactive speech recognition system 102, for example, via the result delivery component 142. For example, the second text result 130 may be obtained in response to the correction request 146.

According to an example embodiment, transmission of the selection indication indicating the error in the first speech-to-text translation, and the second plurality of audio features associated with the second utterance may be initiated (428). For example, the receiving device 118 may initiate transmission of the selection indication to the interactive speech recognition system 102.

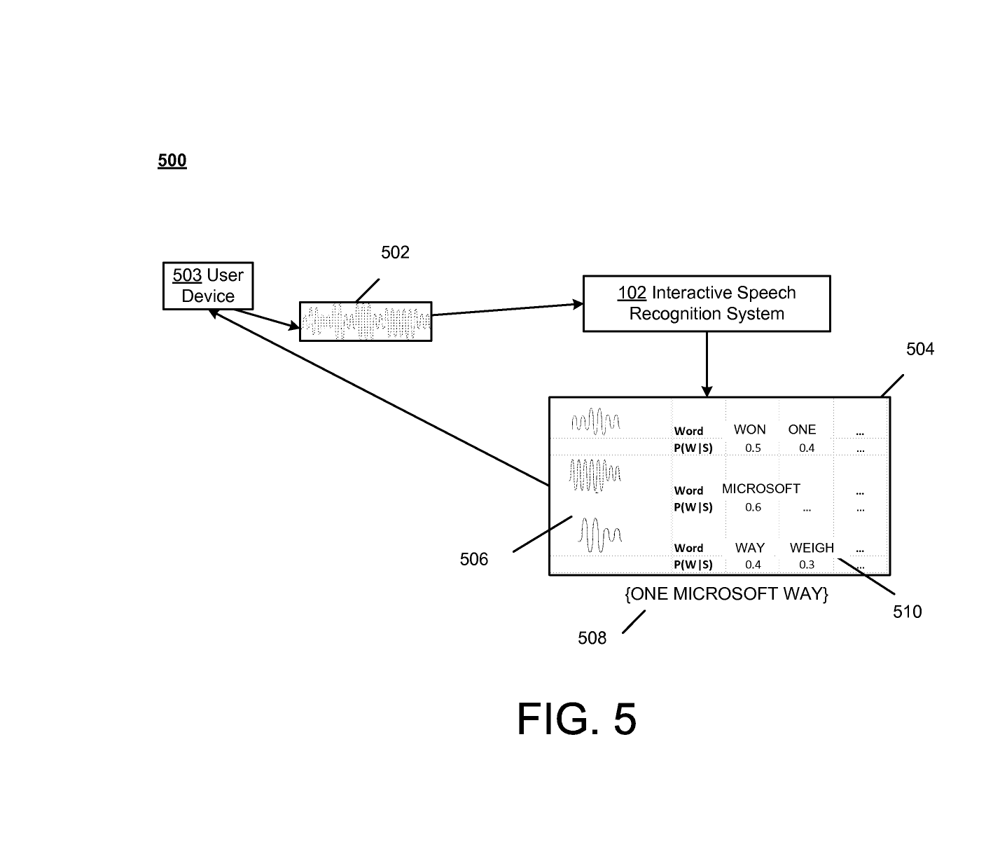

FIG. 5 depicts an example interaction with the system of FIG. 1. As shown in FIG. 5, the interactive speech recognition system 102 may obtain audio features 502 (e.g., the audio features 106) from a user device 503 (e.g., the receiving device 118). For example, a user (e.g., the user 116) may utter a phrase (e.g., “ONE MICROSOFT WAY”), and the utterance may be received by the user device 503 as audio signals, which may be obtained by the interactive speech recognition system 102 as the audio features 502, as discussed above.

The interactive speech recognition system 102 obtains a recognition of the audio features, and provides a response 504 that includes the text result 130. As shown in FIG. 5, the response 504 includes correlated audio clips 506 (e.g., the portions 140 of the audio features 106), a text string 508 and translation probabilities 510 associated with each translated word. For example, the response 504 may be obtained by the user device 503.

According to an example embodiment, discussed below, the speech signal (e.g., audio features 106) may be sent to a cloud processing system for recognition. The recognized sentence may then be sent to the user device. If the sentence is correctly recognized then the user device 503 may perform an action related to an application (e.g., search on a map). One skilled in the art of data processing will understand that many types of devices may be used as the user device 503. For example, the user device 503 may include one or more mobile devices, one or more desktop devices, or one or more servers. Further, the interactive speech recognition system 102 may be hosted on a backend server, separate from the user device 503, or it may reside on the user device 503, in whole or in part.

If the interactive speech recognition system 102 misclassifies one or more words, then the user (e.g., user 116) may indicate the incorrectly recognized word. The misclassified word (or an indicator thereof) may be sent to the interactive speech recognition system 102. According to example embodiments, either a next probable word is returned (after eliminating the incorrectly recognized word), or k similar words may be sent to the user device 503, depending on user settings. In the first scenario, if the word is a correct translation, the user device 503 may perform the desired action, and in the second scenario, the user may selects one of the similar sounding words (e.g., one of the text alternatives 156).

As shown in FIG. 5, the probability distribution table for a “P(W|S)” may be used to indicate a probability of a word W, given features S (e.g., Mel-frequency Cepstral Coefficients (MFCC), mathematical coefficients for sound modeling) extracted from the audio signal, according to an example embodiment.

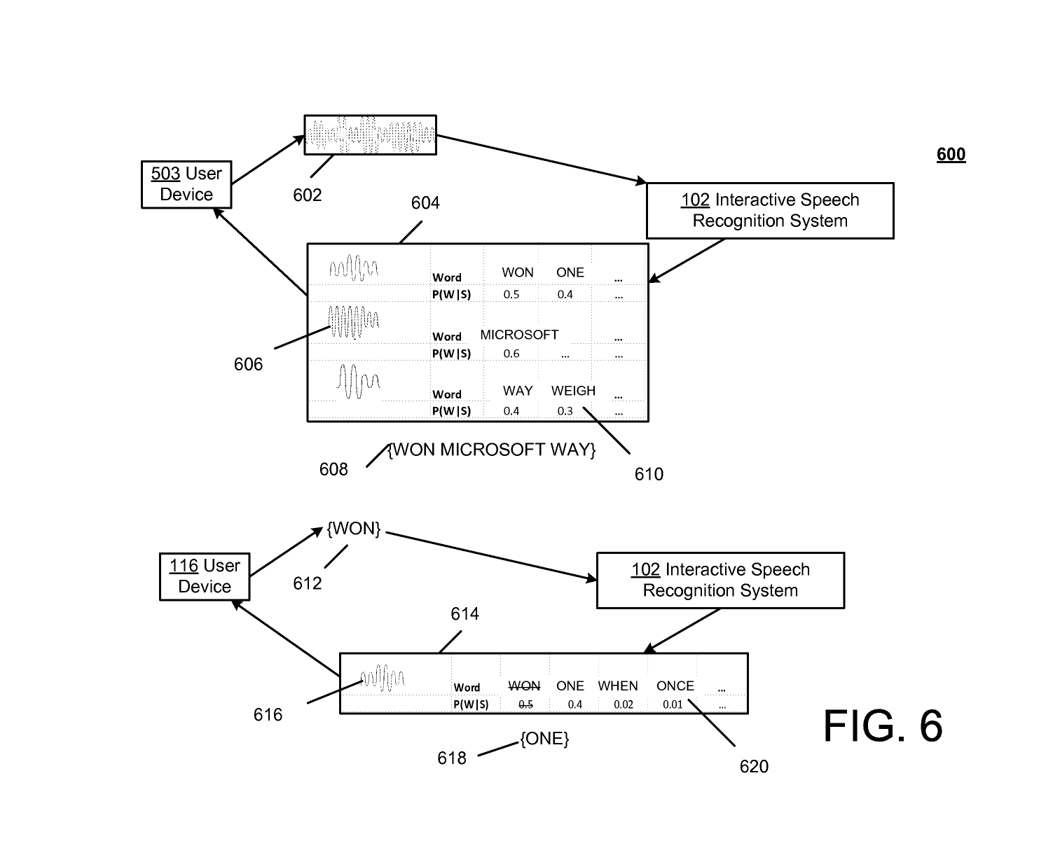

FIG. 6 depicts an example interaction with the system of FIG. 1, according to an example embodiment. As shown in FIG. 6, the interactive speech recognition system 102 may obtain audio features 602 (e.g., the audio features 106) from a user device 503 (e.g., the receiving device 118). For example, a user (e.g., the user 116) may utter the phrase (e.g., “ONE MICROSOFT WAY”), and the utterance may be received by the user device 503 as audio signals, which may be obtained by the interactive speech recognition system 102 as the audio features 602, as discussed above.

The interactive speech recognition system 102 obtains a recognition of the audio features, and provides a response 604 that includes the text result 130. As shown in FIG. 6, the response 604 includes correlated audio clips 606 (e.g., the portions 140 of the audio features 106), a text string 608, and translation probabilities 610 associated with each translated word. For example, the response 604 may be obtained by the user device 503.

After the system sends the recognized sentence “WON MICROSOFT WAY” (608), the user may then indicate an incorrectly recognized word “WON” 612. The word “WON” 612 may then be obtained by the interactive speech recognition system 102. The interactive speech recognition system 102 may then provide a response 614 that includes a correlated audio clip 616 (e.g., correlated portion 140), a next probable word 618 (e.g., “ONE”), and translation probabilities 620 associated with each translated word; however, the incorrectly recognized word “WON” may be omitted from the text alternatives for display to the user. Thus, the user device 503 may obtain the phrase intended by the initial utterance of the user (e.g., “ONE MICROSOFT WAY”).

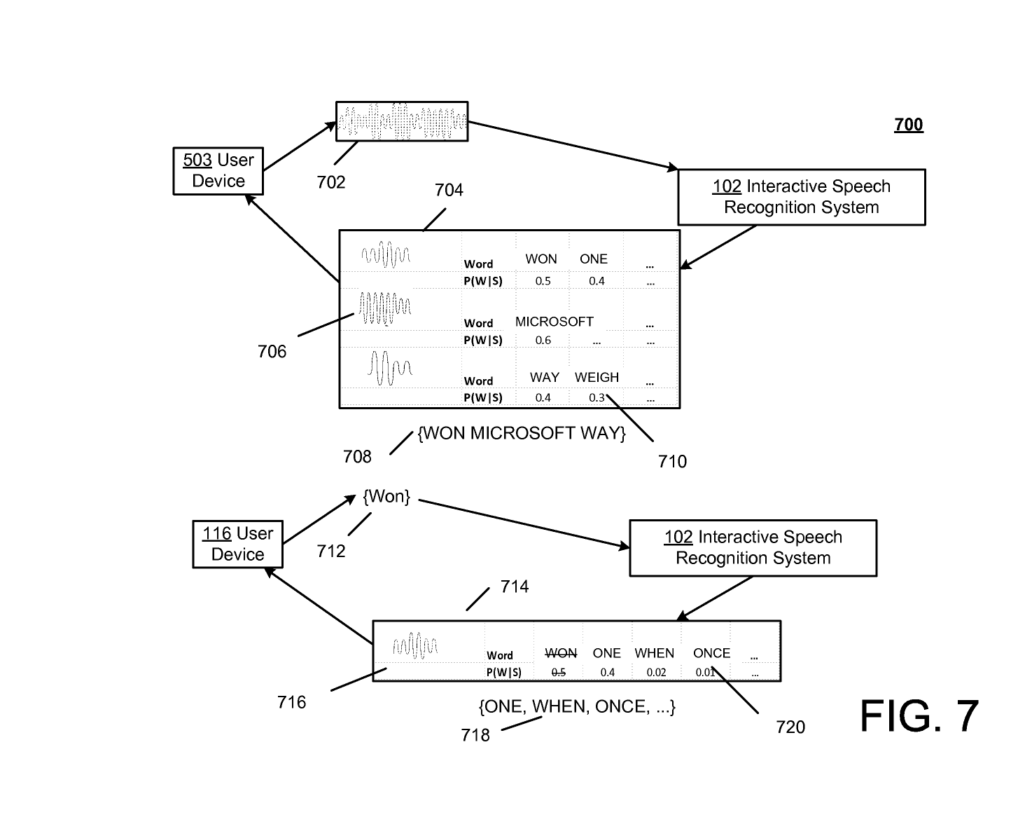

FIG. 7 depicts an example interaction with the system of FIG. 1. As shown in FIG. 7, the interactive speech recognition system 102 may obtain audio features 702 (e.g., the audio features 106) from the user device 503 (e.g., the receiving device 118). As discussed above, a user (e.g., the user 116) may utter the phrase (e.g., “ONE MICROSOFT WAY”), and the utterance may be received by the user device 503 as audio signals, which may be obtained by the interactive speech recognition system 102 as the audio features 602.

The interactive speech recognition system 102 obtains a recognition of the audio features 702, and provides a response 704 that includes the text result 130. As shown in FIG. 7, the response 704 includes correlated audio clips 706 (e.g., the portions 140 of the audio features 106), a text string 708, and translation probabilities 710 associated with each translated word. For example, the response 704 may be obtained by the user device 503.

After the system sends the recognized sentence “WON MICROSOFT WAY” (608), the user may then indicate an incorrectly recognized word “WON” 712. The word “WON” 712 may then be obtained by the interactive speech recognition system 102. The interactive speech recognition system 102 may then provide a response 714 that includes a correlated audio clip 716 (e.g., correlated portion 140), the next k-probable words 718 (e.g., “ONE, WHEN, ONCE, . . . ”), and translation probabilities 720 associated with each translated word; however, the incorrectly recognized word “WON” may be omitted from the text alternatives for display to the user. Thus, the user may then select one of the words and may perform his/her desired action (e.g., search on a map).

According to example embodiments, the interactive speech recognition system 102 may provide a choice for the user to re-utter incorrectly recognized words. This feature may be useful if the desired word is not included in the k similar sounding words (e.g., the text alternatives 156). According to example embodiments, the user may re-utter the incorrectly recognized word, as discussed further below. The audio signal (or audio features) of the re-uttered word and a label indicating the incorrectly recognized word (e.g., “WON”) may then be sent to the interactive speech recognition system 102. The interactive speech recognition system 102 may then recognize the word and provide the probable word W given signal S or k probable words to the user device 503, as discussed further below.

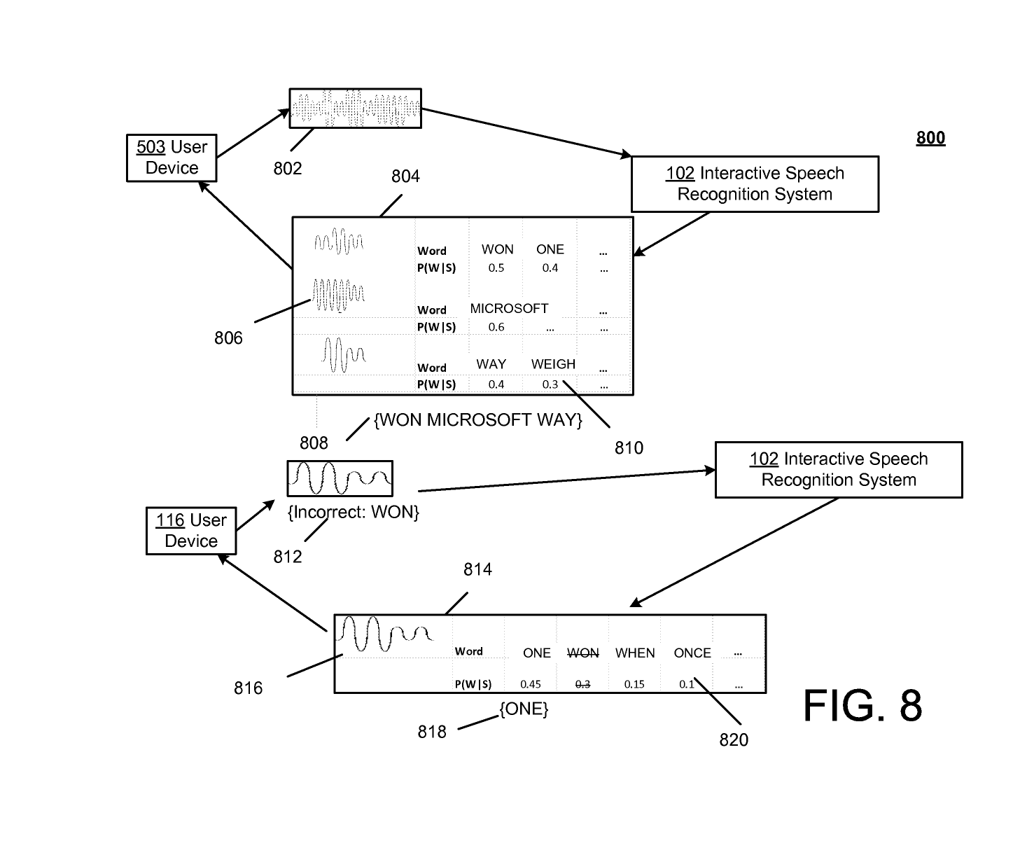

FIG. 8 depicts an example interaction with the system of FIG. 1. As shown in FIG. 8, the interactive speech recognition system 102 may obtain audio features 802 (e.g., the audio features 106) from the user device 503 (e.g., the receiving device 118). As discussed above, a user (e.g., the user 116) may utter the phrase (e.g., “ONE MICROSOFT WAY”), and the utterance may be received by the user device 503 as audio signals, which may be obtained by the interactive speech recognition system 102 as the audio features 802.

The interactive speech recognition system 102 obtains a recognition of the audio features 802, and provides a response 804 that includes the text result 130. As shown in FIG. 8, the response 804 includes correlated audio clips 806 (e.g., the portions 140 of the audio features 106), a text string 808, and translation probabilities 810 associated with each translated word. For example, the response 804 may be obtained by the user device 503.

After the system sends the recognized sentence “WON MICROSOFT WAY” (808), the user may then indicate an incorrectly recognized word “WON”, and may re-utter the word “ONE”. The word “WON” and audio features associated with the re-utterance 812 may then be obtained by the interactive speech recognition system 102. The interactive speech recognition system 102 may then provide a response 814 that includes a correlated audio clip 816 (e.g., correlated portion 140), the next most probable word 818 (e.g., “ONE”), and translation probabilities 720 associated with each translated word; however, the incorrectly recognized word “WON” may be omitted from the text alternatives for display to the user.

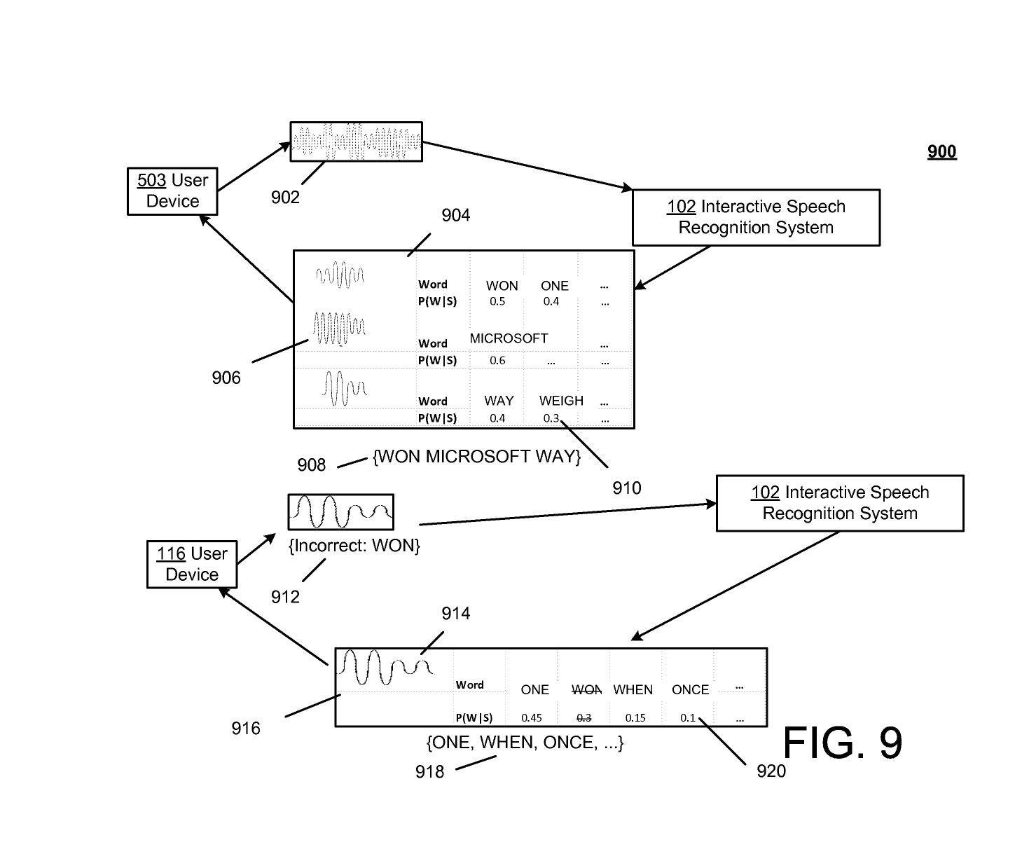

FIG. 9 depicts an example interaction with the system of FIG. 1. As shown in FIG. 9, the interactive speech recognition system 102 may obtain audio features 902 (e.g., the audio features 106) from the user device 503 (e.g., the receiving device 118). As discussed above, a user (e.g., the user 116) may utter the phrase (e.g., “ONE MICROSOFT WAY”), and the utterance may be received by the user device 503 as audio signals, which may be obtained by the interactive speech recognition system 102 as the audio features 902.

The interactive speech recognition system 102 obtains a recognition of the audio features 902, and provides a response 904 that includes the text result 130. As shown in FIG. 9, the response 904 includes correlated audio clips 906 (e.g., the portions 140 of the audio features 106), a text string 908, and translation probabilities 910 associated with each translated word; however, the incorrectly recognized word “WON” may be omitted from the text alternatives for display to the user. For example, the response 904 may be obtained by the user device 503.

After the system sends the recognized phrase “WON MICROSOFT WAY” (908), the user may then indicate an incorrectly recognized word “WON”, and may re-utter the word “ONE”. The word “WON” and audio features associated with the re-utterance 912 may then be obtained by the interactive speech recognition system 102. The interactive speech recognition system 102 may then provide a response 914 that includes a correlated audio clip 916 (e.g., correlated portion 140), the next k-most probable words 918 (e.g., “ONE, WHEN, ONCE, . . . ”), and translation probabilities 920 associated with each translated word. Thus, the user may then select one of the words and may perform his/her desired action (e.g., search on a map).

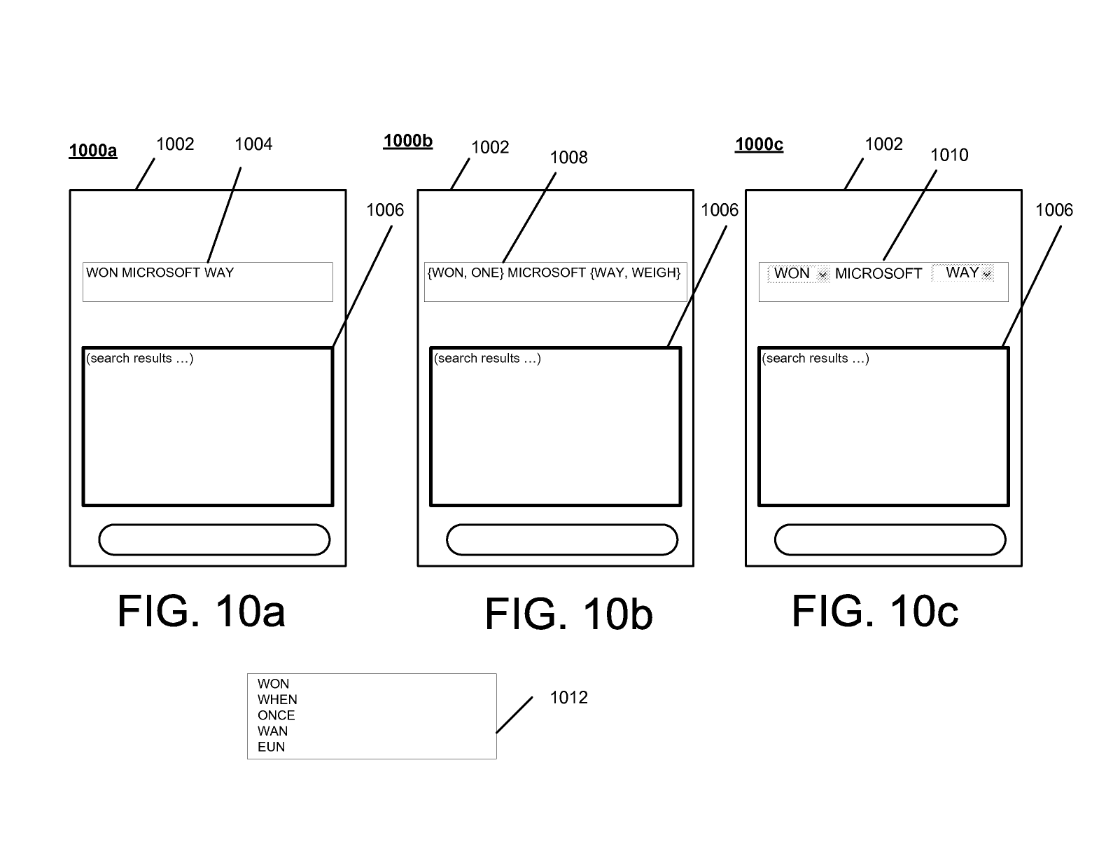

FIG. 10 depicts an example user interface for the system of FIG. 1, according to example embodiments. As shown in FIG. 10a, a user device 1002 may include a text box 1004 and an application activity area 1006. As shown in FIG. 10a, the interactive speech recognition system 102 provides a response to an utterance, “WON MICROSOFT WAY”, which may be displayed in the text box 1004. According to an example embodiment, the user may then select an incorrectly translated word (e.g., “WON”) based on selection techniques such as touching the incorrect word or selecting the incorrect word by dragging over the word. According to example embodiments, the user device 1002 may application activity (e.g., search results) in the display application activity area 1006. For example, the application activity may be revised with each version of the text string displayed in the text box 1004 (e.g., original translated phrase, corrected translated phrases).

As shown in FIG. 10b, the user device 1002 may include a text box 1008 and the application activity area 1006. As shown in FIG. 10b, the interactive speech recognition system 102 provides a response to an utterance, “{WON, ONE} MICROSOFT {WAY, WEIGH}”, which may be displayed in the text box 1004.

Thus, lists of alternative strings are displayed within delimiter text brackets (e.g., alternatives “WON” and “ONE”) so that the user may select a correct alternative from each list.

As shown in FIG. 10c, the user device 1002 may include a text box 1010 and the application activity area 1006. As shown in FIG. 10c, the interactive speech recognition system 102 provides a response to an utterance, “WON MICROSOFT WAY”, which may be displayed in the text box 1010 with the words “WON” and “WAY” displayed as drop-down menus for drop-down lists of text alternatives. For example, the drop-down menu associated with “WON” may appear as indicated by a menu 1012 (e.g., indicating text alternatives “WON”, “WHEN”, “ONCE”, “WAN”, “EUN”). According to example embodiments, the menu 1012 may also be displayed as a pop-up menu in response to a selection of selectable text that includes “WON” in the text boxes 1004 or 1008.

Example techniques discussed herein may provide misclassified words in requests for correction, thus providing systematic learning from user feedback, removing words returned in previous attempts from possible candidates, and thus providing recognition accuracy, reducing load on the system, and lowering bandwidth needs for translation attempts following the first attempt.

Example techniques discussed herein may provide improved the recognition accuracy, as words identified as misclassified by the user are eliminated form future consideration as a candidate for translation of the utterance portion.

Example techniques discussed herein may provide reduced loads on systems by sending misclassified words rather than sending the entire sentence speech signals, which may reduce load on processing and bandwidth resources.

Example techniques discussed herein may provide recognition accuracy based on segmented speech recognition (e.g., correct one word at a time).

According to example embodiments, the interactive speech recognition system 102 may utilize recognition systems based on one or more of Neural Networks, Hidden Markov Models, Linear Discriminant Analysis, or any modeling technique applied to recognize the speech. For example, speech recognition techniques may be used as discussed in Lawrence Rabiner and Biing-Hwang Juang, Fundamentals of Speech Recognition, Prentice-Hall, 1993, or in Lawrence R. Rabiner, “A Tutorial on Hidden Markov Models and Selected Applications in Speech Recognition,” Proceedings of the IEEE, Vol. 77, No. 2, 1989.

Customer privacy and confidentiality have been ongoing considerations in online environments for many years. Thus, example techniques for determining interactive speech-to-text translation may use data provided by users who have provided permission via one or more subscription agreements with associated applications or services.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product tangibly embodied on a computer-readable storage medium and including executable code that causes at least one data processing apparatus to:
obtain audio data associated with a first utterance;
obtain, via a device processor, a text result associated with a first speech-to-text translation of the first utterance based on an audio signal analysis associated with the audio data, the text result including a plurality of selectable text alternatives corresponding to at least one word;
initiate a display of at least a portion of the text result that includes a first one of the text alternatives; and
receive a selection indication indicating a second one of the text alternatives.

2. The computer program product of claim 1, wherein:
obtaining the text result includes obtaining, via the device processor, search results based on a search query based on the first one of the text alternatives.

3. The computer program product of claim 1, wherein:
the audio data includes one or more of:
audio features determined based on a quantitative analysis of audio signals obtained based on the first utterance, or
the audio signals obtained based on the first utterance.

4. The computer program product of claim 1, wherein the executable code is configured to cause the at least one data processing apparatus to:
obtain search results based on a search query based on the second one of the text alternatives; and
initiate a display of at least a portion of the search results.

5. The computer program product of claim 1, wherein:
obtaining the text result associated with the first speech-to-text translation of the first utterance includes obtaining a first segment of the audio data correlated to a translated portion of the first speech-to-text translation of the first utterance to the second one of the text alternatives, and
a plurality of translation scores, wherein each of the plurality of selectable text alternatives is associated with a corresponding one of the translation scores indicating a probability of correctness in text-to-speech translation,
wherein the first one of the text alternatives is associated with a first translation score indicating a highest probability of correctness in text-to-speech translation among the plurality of selectable text alternatives.

6. The computer program product of claim 5, wherein the executable code is configured to cause the at least one data processing apparatus to:
initiate transmission of the selection indication indicating the second one of the text alternatives and the first portion of the audio data.

7. The computer program product of claim 1, wherein:
initiating the display of at least the portion of the text result that includes the first one of the text alternatives includes initiating the display of one or more of:
a list delimited by text delimiters,
a drop-down list, or
a display of the first one of the text alternatives that includes a selectable link associated with a display of at least the second one of the text alternatives in a pop-up display frame.

8. A method comprising:
obtaining a first plurality of audio features associated with a first utterance;
obtaining, via a device processor, a first text result associated with a first speech-to-text translation of the first utterance based on an audio signal analysis associated with the audio features, the first text result including at least one first word;
obtaining a first set of audio features correlated with at least a first portion of the first speech-to-text translation associated with the at least one first word;
initiating a display of at least a portion of the first text result that includes the at least one first word; and
receiving a selection indication indicating an error in the first speech-to-text translation, the error associated with the at least one first word.

9. The method of claim 8, wherein:
the first speech-to-text translation of the first utterance includes a speaker independent speech recognition translation of the first utterance.

10. The method of claim 8, further comprising:
obtaining a second text result based on an analysis of the first speech-to-text translation of the first utterance and the selection indication indicating the error.

11. The method of claim 8, further comprising:
initiating transmission of the selection indication indicating the error in the first speech-to-text translation, and the set of audio features correlated with at least a first portion of the first speech-to-text translation associated with the at least one first word.

12. The method of claim 8, wherein:
receiving the selection indication indicating the error in the first speech-to-text translation, the error associated with the at least one first word includes one or more of:
receiving an indication of a user touch on a display of the at least one first word,
receiving an indication of a user selection based on a display of a list of alternatives that include the at least one first word,
receiving an indication of a user selection based on a display of a drop-down menu of one or more alternatives associated with the at least one first word, or
receiving an indication of a user selection based on a display of a popup window of a display of the one or more alternatives associated with the at least one first word.

13. The method of claim 8, wherein:
the first text result includes a second word different from the at least one word, wherein the method further comprises:
obtaining a second set of audio features correlated with at least a second portion of the first speech-to-text translation associated with the second word, wherein the second set of audio features are based on a substantially nonoverlapping timing interval in the first utterance, compared with the at least one word.

14. The method of claim 8, further comprising:
obtaining a second plurality of audio features associated with a second utterance, the second utterance associated with verbal input associated with a correction of the error associated with the at least one first word; and
obtaining, via the device processor, a second text result associated with a second speech-to-text translation of the second utterance based on an audio signal analysis associated with the second plurality of audio features, the second text result including at least one corrected word different from the first word.

15. The method of claim 14, further comprising:
initiating transmission of the selection indication indicating the error in the first speech-to-text translation, and the second plurality of audio features associated with the second utterance.

16. A system comprising:
an input acquisition component that obtains a first plurality of audio features associated with a first utterance;
a speech-to-text component that obtains, via a device processor, a first text result associated with a first speech-to-text translation of the first utterance based on an audio signal analysis associated with the audio features, the first text result including at least one first word;
a clip correlation component that obtains a first correlated portion of the first plurality of audio features associated with the first speech-to-text translation to the at least one first word;
a result delivery component that initiates an output of the first text result and the first correlated portion of the first plurality of audio features; and
a correction request acquisition component that obtains a correction request that includes an indication that the at least one first word is a first speech-to-text translation error, and the first correlated portion of the first plurality of audio features. Docket No. 333249.01

17. The system of claim 16, further comprising:
a search request component that initiates a first search operation based on the first text result associated with the first speech-to-text translation of the first utterance, wherein:
the result delivery component initiates the output of the first text result and the first correlated portion of the first plurality of audio features with results of the first search operation.

18. The system of claim 16, wherein:
the speech-to-text component obtains, via the device processor, the first text result associated with the first speech-to-text translation of the first utterance based on the audio signal analysis associated with the first plurality of audio features, the first text result including a plurality of text alternatives, the at least one first word included in the plurality of first text alternatives, wherein
the first correlated portion of the first plurality of audio features associated with the first speech-to-text translation to the at least one first word is associated with the plurality of first text alternatives.

19. The system of claim 18, wherein:
each of the plurality of first text alternatives is associated with a corresponding translation score indicating a probability of correctness in text-to-speech translation,
wherein the at least one first word is associated with a first translation score indicating a highest probability of correctness in text-to-speech translation among the plurality of first text alternatives,
wherein the output of the first text result includes an output of the plurality of first text alternatives and the corresponding translation scores.

20. The system of claim 19, wherein:
the result delivery component initiates the output of the first text result, the first correlated portion of the first plurality of audio features, and at least a portion of the corresponding translation scores; and
the correction request acquisition component obtains the correction request that includes the indication that the at least one first word is a first speech-to-text translation error, and one or more of:
the first correlated portion of the first plurality of audio features, and the at least a portion of the corresponding translation scores, or a second plurality of audio features associated with a second utterance corresponding to verbal input associated with a correction of the first speech-to-text translation error based on the at least one first word.
